(19) United States
(12) Patent Application Publication
(10) Pub. No.: US 2013/0193617 A1
(43) Pub. Date: Aug. 1, 2013

(54) SYSTEMS AND METHODS FOR SEPARATING NON-METALLIC MATERIALS

(71) Applicant: Haibin Zhang, Portland, OR (US)

(72) Inventor: Haibin Zhang, Portland, OR (US)

(73) Assignee: ELECTRO SCIENTIFIC INDUSTRIES, INC., Portland, OR (US)

(21) Appl. No.: 13/364,099

(22) Filed: Feb. 1, 2012

(51) Int. Cl. B29B 13/08

(52) U.S. Cl. 264/400; 425/174.4

(57) ABSTRACT

A non-metallic material is separated using a single laser beam that is converted into a scribe beam and a break beam. A system includes a single laser source for generating a laser beam and a beam separator for converting the laser beam into a scribe beam having a first average power and a break beam having second average power. The beam separator directs the scribe beam to a scribe line on a substrate and the break beam to the substrate at a location that is spaced apart from the scribe beam. The scribe beam rapidly heats the substrate along the scribe line. A quenching subsystem applies a stream of cooling fluid to the substrate to propagate a microcrack along the scribe line. The break beam rapidly reheats the substrate quenched by the stream of cooling fluid to separate the substrate along the microcrack.

### TECHNICAL FIELD

This disclosure relates to separating non-metallic materials into a plurality of smaller pieces. In particular, this disclosure is directed to using a single laser source to generate a scribe beam and a break beam for use with a cooling source to separate glass, silicon, ceramic, or other non-metallic materials.

### BACKGROUND

High-power lasers (e.g., 500 W CO₂ lasers) may cut through non-metallic substrates such as glass, silicon, or ceramic by melting, evaporation, and ejection of material, which leads to poor surface integrity, wide tolerances, and degraded strength. Other methods for separating a non-metallic material use a non-melting (or non-evaporation) thermal process followed by a strain process. For the thermal process, any brittle material exceeds its critical thermal shock temperature when its temperature is elevated to a desired level and then rapidly cooled or quenched to break its molecular bonds. This forms a “vent” or “blind crack” in the material. Certain thermal processes use a first laser source to generate a first laser beam that heats the material along a scribe line. The first laser beam may be closely followed by a cooling stream of fluid (e.g., Helium and/or water) for quenching.

The strain process may then be used to completely separate the material by breaking the material along the blind crack using either traditional mechanical methods or a second laser process. Mechanical strain may include, for example, using a “guillotine” breaker to apply sufficient physical force to a thin substrate (e.g., less than about 0.5 mm) so as to completely break the substrate along the scribe line. For thicker material, however, the residual tensile forces resulting from the laser scribing operation may not be sufficient to cleanly separate the material using mechanical force. Thus, a second laser source may be used to generate a second laser beam to rapidly reheat the substrate along the scribe line, following the quenching step, to fully separate the material. Using two lasers, however, increases system complexity and maintenance.

### SUMMARY

A non-metallic material is separated using a single laser beam that is converted into a scribe beam and a break beam. A system includes a single laser source for generating a laser beam and a beam separator for converting the laser beam into a scribe beam having a first average power and a break beam having second average power. The beam separator directs the scribe beam along a first path to a scribe line on a non-metallic substrate and the break beam along a second path to the non-metallic substrate at a location that is spaced apart from the scribe beam. The scribe beam rapidly heats the non-metallic substrate along the scribe line. A quenching subsystem applies a stream of cooling fluid to the non-metallic substrate to propagate a microcrack along the scribe line heated by the scribe beam. The break beam rapidly reheats the non-metallic substrate quenched by the stream of cooling fluid to separate the non-metallic substrate along the microcrack.

Additional aspects and advantages will be apparent from the following detailed description of preferred embodiments, which proceeds with reference to the accompanying drawings.

### BRIEF DESCRIPTION OF THE DRAWINGS

FIG. 1 is a block diagram of a laser processing system for separating a non-metallic material according to one embodiment.

FIGS. 2A, 2B, and 2C graphically illustrate how the power of a CW laser beam is distributed with respect to time between a scribe beam and a break beam according to an example embodiment.

FIG. 3 is a schematic diagram of a top view of the material shown in FIG. 1 illustrating relative locations of laser beam spots and a quenching location along a scribe line according to one embodiment.

FIG. 4 is a schematic diagram of a top view of the material shown in FIG. 1 illustrating dual laser beam spots corresponding to the break beam according to one embodiment.

FIG. 5A is a block diagram of a laser processing system for separating the non-metallic material according to one embodiment.

FIG. 5B is a block diagram of a laser processing system for separating the non-metallic material according to another embodiment.

FIG. 6 is a block diagram of a dual-path laser processing system for separating the non-metallic material according to another embodiment.

FIGS. 7A and 7B graphically illustrate how an AOM distributes and modulates the power of the CW laser beam between the scribe beam and the break beam according to an example embodiment.

### DETAILED DESCRIPTION OF PREFERRED EMBODIMENTS

Systems and methods separate a non-metallic material by converting a laser beam from a single laser source into a scribe beam and a break beam. By way of example, and not by limitation, the non-metallic material may include glass, silicon, ceramic, or other material. The average power of the scribe beam is selected so as to propagate, in cooperation with a cooling stream, a microcrack along a desired scribe line in the non-metallic material, without substantially ablating (e.g., melting, evaporating, and/or ejecting) the material. The average power of the break beam is selected to produce a tensile force along the scribe line so as to break the material into separate pieces.

In one embodiment, a continuous wave (CW) laser beam is “time-shared” between the scribe beam and the break beam using, for example, a fast steering mirror (FSM), a mirror galvanometer beam deflector (referred to herein as a “galvo” or “galvo mirror”), an acousto-optic deflector (AOD), an electro-optic deflector (EOD), other optical deflection devices, or a combination of the foregoing. In such embodiments, the CW beam is deflected along a scribing beam path during certain time periods and along a breaking beam path during other time periods. As discussed below, the average powers of the respective beams may be controlled by selecting duty cycles for the scribe beam and the break beam.

In addition, or in other embodiments, the respective average powers may be controlled by selectively modulating the scribe beam and the break beam. For example, as discussed in detail below, an acousto-optic modulator (AOM) may receive the CW beam and output both (e.g., as a 0th order beam and a 1st order beam) a modulated scribe beam and a modulated break beam.

The average power of the scribe beam is selected to heat the material with little or no ablation, and to keep the surface temperature of the material (e.g., glass) below the “transition” temperature to avoid damaging the integrity of the material. Once a quenching jet is applied, the surface of the glass contracts while the center is still under expansion, which results in large surface tensile stress. When such tensile stress exceeds the critical breaking point of glass, a vent is created which follows the path defined by the scribe beam and the cooling nozzle. Depending on the material, a cooling liquid jet, a mix of liquid and gas, or even gas alone may be used for quenching. For certain materials, such as those with low thermal expansion coefficients, a high gradient may be required to exceed the critical breaking stress. In such embodiments, a gas/water mixture may be used for effective quenching. In other words, latent heat released from the evaporation of the liquid is combined with convective and conductive heat transfer and serves to quench the material in a more efficient manner, thereby providing fast temperature quenching and creating a large thermal gradient for high tensile stress.

In certain embodiments, an initial defect, e.g., a notch on the edge or a small crack, may be required to propagate a microcrack through a material. Many materials already have defects positioned along their edges as result of previous manufacturing processes. It has been found more desirable, however, to introduce an initiation defect in a controlled manner at a given location rather than to rely on residual defects.

Reference is now made to the figures in which like reference numerals refer to like elements. For clarity, the first digit of a reference numeral indicates the figure number in which the corresponding element is first used. In the following description, numerous specific details are provided for a thorough understanding of the embodiments disclosed herein. However, those skilled in the art will recognize that the embodiments can be practiced without one or more of the specific details, or with other methods, components, or materials. Further, in some cases, well-known structures, materials, or operations are not shown or described in detail in order to avoid obscuring aspects of the invention. Furthermore, the described features, structures, or characteristics may be combined in any suitable manner in one or more embodiments.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a non-transitory, machine-readable medium having stored thereon instructions that may be used to program a computer (or other electronic device) to perform the processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/computer-readable medium suitable for storing electronic instructions.

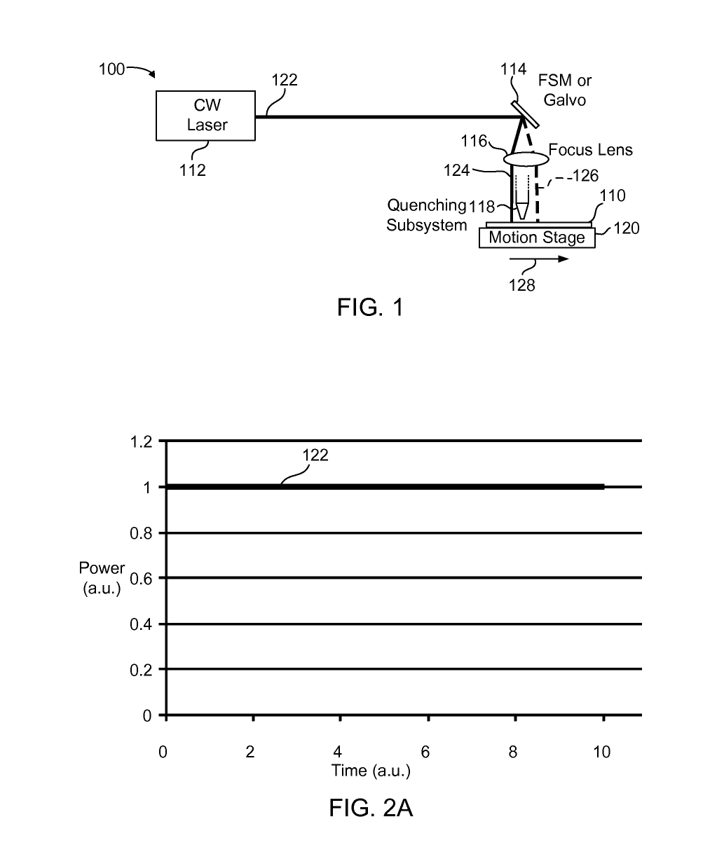

FIG. 1 is a block diagram of a laser processing system 100 for separating a non-metallic material 110 according to one embodiment. The system 100 includes a single CW laser source 112, a steerable deflector 114, a focus lens 116, a quenching subsystem 118, and a motion stage 120. The CW laser source 112 is configured to output a CW laser beam 122 at a predetermined wavelength and average power selected to process a particular type of material 110. By way of example only, and not by limitation, the CW laser source 112 may comprise a carbon dioxide (CO₂) laser configured to output the laser beam 122 having a wavelength in a range between about 9 μm and about 11 μm. In certain examples discussed herein, the CW laser beam 122 has an average power in a range between about 700 W and about 750 W. However, skilled persons will recognize from the disclosure herein that these values are provided as one example, and that any wavelength or average power may be used based on material or laser process. Further, in other embodiments, the CW laser source 112 may be replaced with a pulsed laser wherein different pulses are directed along respective scribing and breaking paths.

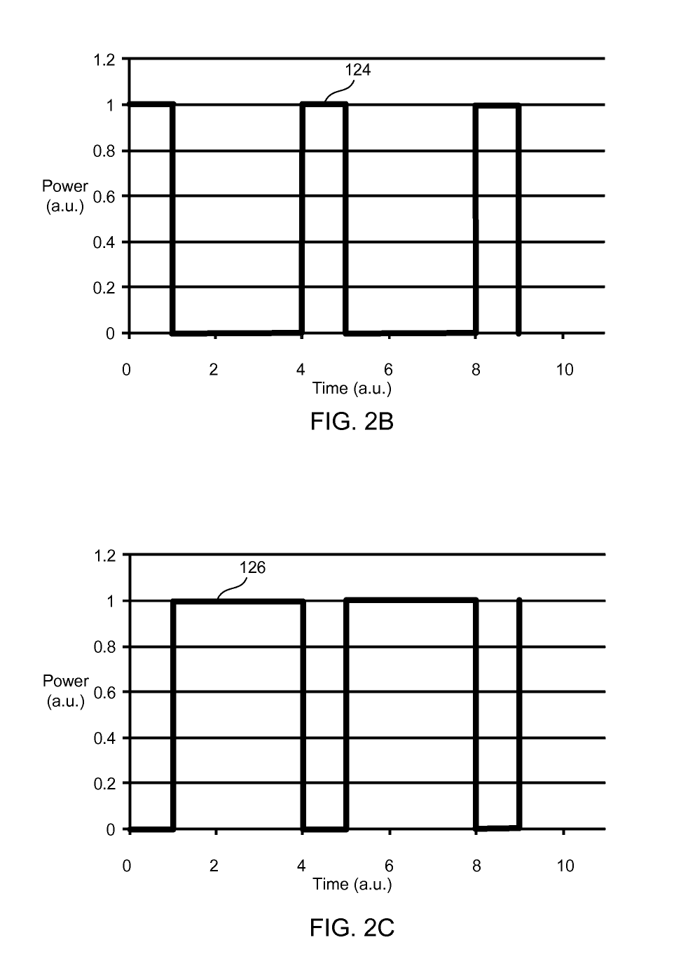

As shown in FIG. 1, the steerable deflector 114 may include an FSM, galvo, or other deflector that may be controlled to receive the laser beam 122 from the CW laser source 112 and to selectively deflect the laser beam 122 along either a first path corresponding to a scribe beam 124 or a second path corresponding to a break beam 126. In certain embodiments, the steerable deflector 114 may selectively operate over a range of frequencies to provide desired heating of the material. For example, glass may dissipate heat on the order of milliseconds. By deflecting the laser beam 122 between the scribe beam 124 and the break beam 126 at a high frequency (e.g., greater than or equal to 1 kHz), the pulses in each beam 124, 126 (see FIGS. 2B and 2C) are separated by 1 millisecond or less. Thus, at such a switching frequency, both the scribe beam 124 and the break beam 126 provide continuous heating to a glass material.

For illustrative purposes, the scribe beam 124 is shown with a solid line and the break beam 126 is shown with a dashed line. In this embodiment, the steerable deflector 114 time-shares the laser beam 122 between the two paths. By way of example, time-sharing may result in the 750 W laser beam 122 being divided such that the scribe beam 124 has an average power of about 250 W and the break beam 126 has an average power of about 500 W. Skilled persons will recognize, however, that the power of the laser beam 122 may be distributed in any way between the scribe beam 124 and the break beam 126, depending on the particular material being separated and the particular laser processing application, including distributing more power to the scribe beam 124 than to the break beam 126. In certain embodiments, parameters (e.g., spot size or shape) of the scribe beam 124 and the break beam 126 may be selectively and separately controlled by additional optical elements (not shown) in the respective scribing and breaking beam paths.

FIGS. 2A, 2B, and 2C graphically illustrate how the power of the CW laser beam 122 is distributed with respect to time between the scribe beam 124 and the break beam 126 according to an example embodiment. For illustrative purposes, both power and time are shown in arbitrary units (a.u.). FIG. 2A shows the power with respect to time for the CW laser beam 122 output by the laser source. FIG. 2B shows the power with respect to time for the scribe beam 124. FIG. 2C shows the power with respect to time for the break beam 126. In this example, the steerable deflector 114 directs 100% of the laser power along the path corresponding to the scribe beam 124 during time periods between 0 to about 1 a.u., between about 4 a.u. to about 5 a.u., and between about 8 a.u. to about 9 a.u. along the time axis. During the scribe beam's off times, the steerable deflector 114 directs 100% of the laser power along the path corresponding to the break beam 126 (e.g., from about 1 a.u. and about 4 a.u., and from about 5 a.u. and about 8 a.u. along the time axis). Thus, in this example, about 25% of the power is distributed to the scribe beam 124 and about 75% of the power is distributed to the break beam 126.

Returning to FIG. 1, the motion stage 120 provides relative motion between the laser beams 124, 126 and the material 110 along the scribe line. In this example, the motion stage 120 moves the material 110 to the right, as indicated by arrow 128 such that the scribe beam 124 is followed by a cooling stream (not shown) output by the quenching subsystem 118, which in turn is followed by the break beam 126.

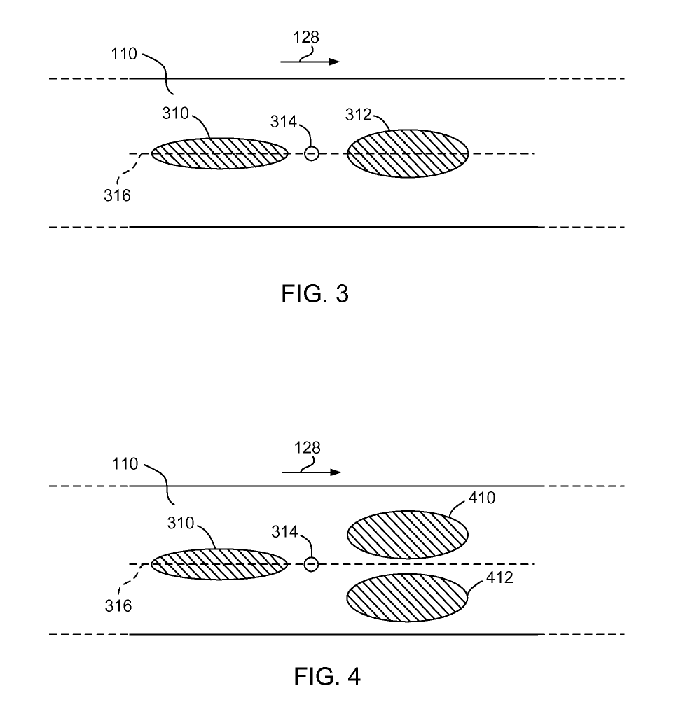

For example, FIG. 3 is a schematic diagram of a top view of the material 110 shown in FIG. 1 illustrating relative locations of laser beam spots 310, 312 and a quenching location 314 along a scribe line 316 according to one embodiment. The laser spots 310, 312 in FIG. 3 are elliptical, with each having its longer axis aligned with the scribe line 316. Skilled persons will recognize from the disclosure herein, however, that circular or other spatially shaped (e.g., rectangular or tapered) beam spots may also be used. Further, the respective distances between the laser beam spots 310, 312 and the quenching location depend on the type of material 110 being processed, heat dissipation within the material 110, laser parameters used (e.g., wavelength, power, and other parameters), and the rate at which the quenching cools the material 110. In this example, the steerable deflector 114 shown in FIG. 1 deflects the portion of the laser beam 122 corresponding to the scribe beam 124 to the laser spot 310 and the portion corresponding to the break beam 126 to the beam spot 312 as the motion stage 120 moves the material in the direction shown by the arrow 128.

In other embodiments, the steerable deflector 114 is configured to deflect in two directions (e.g., in both an X-axis direction and a Y-axis direction). For example, the steerable deflector 114 may include a first FSM to deflect in the X-axis and a second FSM to deflect in the Y-axis. Other configurations are also possible such as an FSM to deflect in a first direction and a galvo to deflect in a second direction. Thus, the steerable deflector 114 may deflect one or both of the beams 124, 126 in a direction that is perpendicular to the scribe line 316.

For example, FIG. 4 is a schematic diagram of a top view of the material 110 shown in FIG. 1 illustrating dual laser beam spots 410, 412 corresponding to the break beam 126 according to one embodiment. In this embodiment, the steerable deflector 114 further divides (e.g., time-shares) the break beam 126 into two break beams that are deflected both in the X-direction (horizontal or in the direction shown by the arrow 128) and in the Y-direction (vertical or in a direction that is perpendicular to the arrow 128). This may be accomplished, for example, by cascading a first deflector (e.g., for the X-axis) followed by a second deflector (e.g., for the Y-axis). As shown in FIG. 4 the laser spots 410, 412 corresponding to the dual break beams may be located on either side of the scribe line 316 to increase the tensile force on the microcrack created by the scribe beam 124 and the quenching subsystem 118.

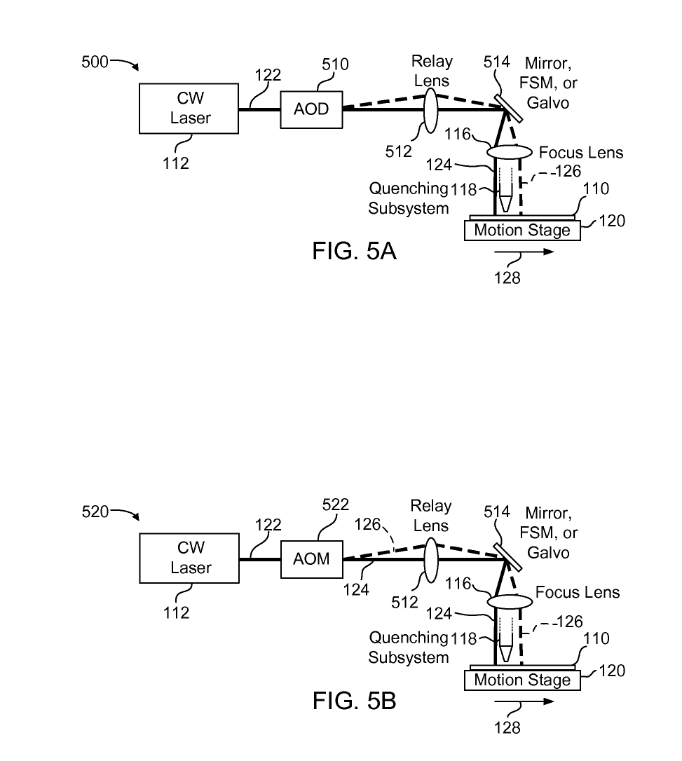

FIG. 5A is a block diagram of a laser processing system 500 for separating the non-metallic material 110 according to one embodiment. The system 500 includes the single CW laser source 112, focus lens 116, quenching subsystem 118, and motion stage 120 discussed above with respect to FIG. 1. In this embodiment, however, the system 500 includes an AOD 510 to selectively deflect the laser beam 122 along either a first path corresponding to the scribe beam 124 or a second path corresponding to the break beam 126. An EOD may be used instead of, or with, the AOD 510. Again, for illustrative purposes, the scribe beam 124 is shown with a solid line and the break beam 126 is shown with a dashed line. In this embodiment, the AOD 510 time-shares the laser beam 122 between the two paths.

The system 500 also includes a relay lens 512 and a deflector 514 for directing the scribe and break beams 124, 126 along their respective paths to the material 110. In one embodiment, the deflector 514 comprises a fixed mirror. In other embodiments, the deflector 514 is a steerable deflector and may include, for example, one or more FSM and/or one or more galvo. In addition, or in other embodiments, the AOD may include a plurality of AODs and/or EODs for selectively deflecting at least one of the scribe beam 124 and the break beam 126 in at least two directions (e.g., in the X-axis direction and the Y-axis direction), as discussed above.

FIG. 5B is a block diagram of a laser processing system 520 for separating the non-metallic material 110 according to another embodiment. The system 520 includes the single CW laser source 112, focus lens 116, quenching subsystem 118, and motion stage 120 discussed above with respect to FIG. 1. The system 520 also includes the relay lens 512 and deflector 514 discussed above with respect to FIG. 5A. In this embodiment, however, the system 520 includes an AOM 522 to separate the laser beam 122 into the scribe beam 124 and the break beam 126, and to selectively modulate the scribe beam 124 and the break beam 126 to further control the respective average powers. In one embodiment, the AOM 522 simultaneously outputs a 0th order beam and a 1st order beam as the scribe beam 124 and the break beam 126. In other embodiments, the AOM 522 may be configured to output two separately controlled 1st order beams as the scribe beam 124 and the break beam 126 (e.g., with the 0th order beam being sent to a beam dump). In addition, or in other embodiments, the AOM 522 includes AOD functionality. In one embodiment, the deflector 514 comprises a fixed mirror. In other embodiments, the deflector 514 is a steerable deflector and may include, for example, one or more FSM and/or one or more galvo.

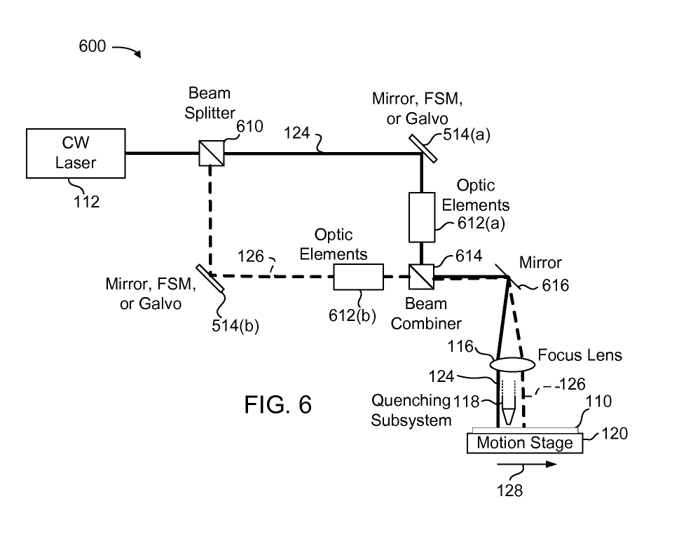

FIG. 6 is a block diagram of a dual-path laser processing system 600 for separating the non-metallic material 110 according to another embodiment. The system 600 includes the single CW laser source 112, focus lens 116, quenching subsystem 118, and motion stage 120 discussed above with respect to FIG. 1. In this embodiment, however, the system 600 includes a beam splitter 610 configured to direct a portion of the laser beam (e.g., the scribe beam 124) down a first optical path including a first deflector 514(a), first optic elements 612(a), if any, and a beam combiner 614. The beam splitter 610 also directs a portion of the laser beam (e.g., the break beam 126) down a second optical path including a second deflector 514(b), second optic elements 612(b), if any, and the beam combiner 614. The beam splitter 610 may include bulk optics such as polarizing beam splitter cubes or partially reflecting mirrors. AODs, EODs, and switchable liquid crystal display (LCD) polarizers may also be configured and driven to perform beam splitting. Alternatively, fiber optic couplers may serve as a beam splitter in fiber-optic implementations.

In certain embodiments, parameters of the scribe beam 124 and the break beam 126 may be selectively and separately controlled. For example, the optic elements 612(a), 612(b) in each path, which are optional, may be included to shape or change the optical properties of the beams and may include, for example, polarizers, polarization modifiers, faraday isolators, spatial beam profile modifiers, temporal beam profile modifiers, frequency shifters, frequency-multiplying optics, attenuators, pulse amplifiers, mode-selecting optics, beam expanders, lenses, and relay lenses. Additional optic elements may also include delay elements that include an extra optical path distance, folded optical paths, and fiber-optic delay lines.

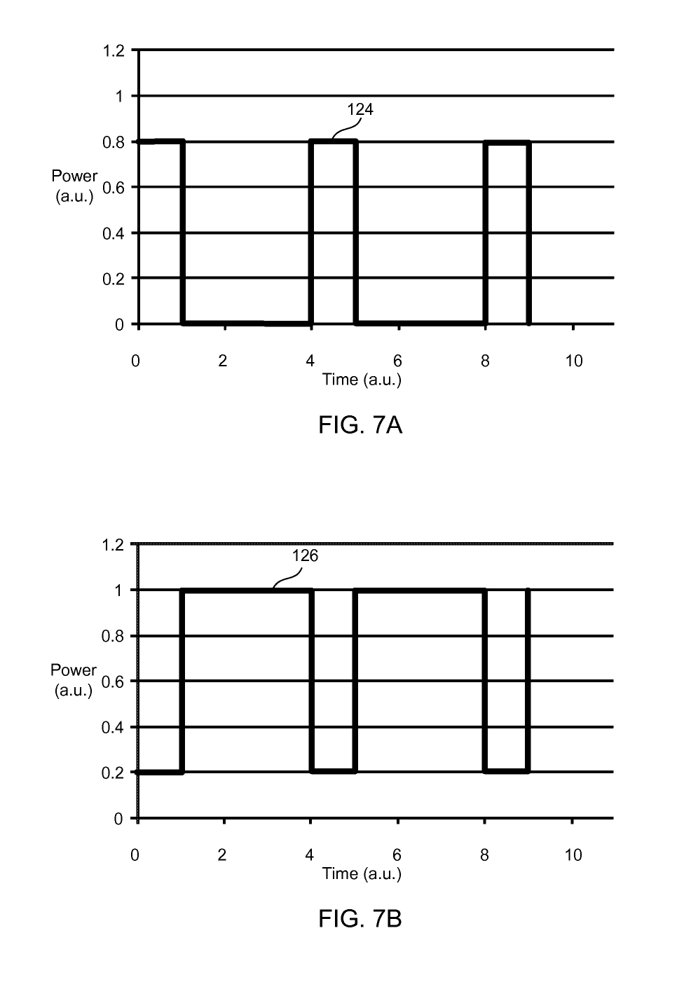

FIGS. 7A and 7B graphically illustrate how the AOM 522 distributes and modulates the power of the CW laser beam 122 between the scribe beam 124 and the break beam 126 according to an example embodiment. For illustrative purposes, both power and time are shown in arbitrary units (a.u.). As discussed above, FIG. 2A shows the power with respect to time for the CW laser beam 122 output by the laser source. FIG. 7A shows the power with respect to time for the scribe beam 124. FIG. 7B shows the power with respect to time for the break beam 126. The example shown in FIG. 7A is similar to the example shown in FIG. 2B, except that the AOM 522 further modulates the power of the scribe beam 124 shown in FIG. 7A between 0% and 80%. Thus, during the on periods of the scribe beam 124 (e.g., 0 to about 1 a.u., from about 4 a.u. to about 5 a.u., and from about 8 a.u. to about 9 a.u. along the time axis), the AOM 522 continues to distribute 20% of the power to the break beam 126, as shown in FIG. 7B. In other words, rather than turning the power completely off for the break beam 126, the AOM 522 maintains at least 20% of the maximum power in the break beam 126 at all times.

It will be understood by those having skill in the art that many changes may be made to the details of the above-described embodiments without departing from the underlying principles of the invention. The scope of the present invention should, therefore, be determined only by the following claims.

1. A system for separating non-metallic substrates, the system comprising:
a single laser source for generating a laser beam;
a beam separator for converting the laser beam into a scribe beam comprising a first average power and a break beam comprising second average power, the beam separator directing the scribe beam along a first path to a scribe line on a non-metallic substrate and the break beam along a second path to the non-metallic substrate at a location that is spaced apart from the scribe beam, the scribe beam rapidly heating the non-metallic substrate along the scribe line; and
a quenching subsystem to apply a stream of cooling fluid to the non-metallic substrate to propagate a microcrack along the scribe line heated by the scribe beam;
wherein the break beam rapidly reheats the non-metallic substrate quenched by the stream of cooling fluid to separate the non-metallic substrate along the microcrack.

2. The system of claim 1, wherein the beam separator is configured to repeatedly deflect the laser beam back and forth in a cycle between the first path and the second path at a selected rate.

3. The system of claim 2, wherein the selected rate defines a first time duration per cycle during which the laser beam is deflected along the first path and a second time duration per cycle during which the laser beam is deflected along the second path, and wherein at least one of the first time duration and the second time duration may be selectively adjusted to change at least one of the first average power and the second average power.

4. The system of claim 2, wherein the beam separator comprises a steerable deflector selected from a group comprising a fast steering mirror and a mirror galvanometer beam deflector.

5. The system of claim 2, wherein the beam separator is selected from a group comprising an acousto-optic deflector and an electro-optic deflector.

6. The system of claim 1, wherein the beam separator is further to:
convert the break beam into a first break beam and a second break beam; and
deflect both the first break beam and the second break beam in a first direction that is parallel to the scribe line and a second direction that is perpendicular to the scribe line so as to simultaneously reheat both sides of the scribe line to separate the non-metallic substrate along the microcrack.

7. The system of claim 1, wherein the beam separator comprises a modulator to selectively modulate the power of at least one of the scribe beam and the break beam.

8. The system of claim 7, wherein the modulator comprises an acousto-optic modulator.

9. The system of claim 1, wherein the beam separator comprises a beam splitter.

10. The system of claim 1, further comprising:
a motion stage to provide relative movement between the non-metallic substrate and the scribe beam, break beam, and stream of cooling fluid, the motion stage scanning the scribe beam and the stream of cooling fluid along scribe line.

11. A method for separating non-metallic substrates, the method comprising:
generating a laser beam from single laser source;
separating the laser beam into a scribe beam comprising a first average power and a break beam comprising second average power;
directing the scribe beam along a first path to a scribe line on a non-metallic substrate and the break beam along a second path to the non-metallic substrate at a location that is spaced apart from the scribe beam, the scribe beam rapidly heating the non-metallic substrate along the scribe line; and
applying a stream of cooling fluid to the non-metallic substrate to propagate a microcrack along the scribe line heated by the scribe beam;
wherein the break beam rapidly reheats the non-metallic substrate quenched by the stream of cooling fluid to separate the non-metallic substrate along the microcrack.

12. The method of claim 11, wherein separating the laser beam comprises repeatedly deflecting the laser beam back and forth in a cycle between the first path and the second path at a selected rate.

13. The method of claim 12, wherein the selected rate defines a first time duration per cycle during which the laser beam is deflected along the first path and a second time duration per cycle during which the laser beam is deflected along the second path, and wherein at least one of the first time duration and the second time duration is selectively adjusted to change at least one of the first average power and the second average power.

14. The method of claim 12, further comprising separating the laser beam using a steerable deflector selected from a group comprising a fast steering mirror and a mirror galvanometer beam deflector.

15. The method of claim 12, further comprising separating the laser beam using a beam separator selected from a group comprising an acousto-optic deflector and an electro-optic deflector.

16. The method of claim 11, wherein separating the laser beam comprises:
converting the break beam into a first break beam and a second break beam; and
deflecting both the first break beam and the second break beam in a first direction that is parallel to the scribe line and a second direction that is perpendicular to the scribe line so as to simultaneously reheat both sides of the scribe line to separate the non-metallic substrate along the microcrack.

17. The method of claim 11, further comprising modulating the laser beam to selectively modulate the power of at least one of the scribe beam and the break beam.

18. The method of claim 17, further comprising modulating the laser beam using an acousto-optic modulator.

19. The method of claim 11, further comprising:
providing relative movement between the non-metallic substrate and the scribe beam, break beam, and stream of cooling fluid to scan the scribe beam and the stream of cooling fluid along scribe line.

20. A system for separating non-metallic substrates, the system comprising:
means for generating a laser beam from single laser source;
means for separating the laser beam into a scribe beam comprising a first average power and a break beam comprising second average power;
means for directing the scribe beam along a first path to a scribe line on a non-metallic substrate and the break beam along a second path to the non-metallic substrate at a location that is spaced apart from the scribe beam, the scribe beam rapidly heating the non-metallic substrate along the scribe line; and
means for applying a stream of cooling fluid to the non-metallic substrate to propagate a microcrack along the scribe line heated by the scribe beam;
wherein the break beam rapidly reheats the non-metallic substrate quenched by the stream of cooling fluid to separate the non-metallic substrate along the microcrack.
